(19) United States
(12) Patent Application Publication
(10) Pub. No.: US 2009/0124232 A1
(43) Pub. Date: May 14, 2009

(54) Emergency warning by mobile telephone

(76) Inventors: John Joseph D'Arcy, Ben Lomond, CA (US); Hans Joachim Von Der Pfordten, Palo Alto, CA (US)

Correspondence Address: Hans J. Von Der Pfordten, 455 East Charleston Rd, Palo Alto, CA, 94306, US

(21) Appl. No.: 11/983,953

(22) Filed: Nov. 13, 2007

(51) Int. Cl. H04M 11/04

(52) U.S. Cl. 455/404.2

(57) ABSTRACT

Cell-phones with their control and voice bands and their wide spread presence plus the good coverage of the US by cell towers makes a pin-pointed alert broadcast to people end angered by severe weather possible, based on data-feeds from NOAA, or by other incidents. Alert-specific programs in audio, video and text are downloaded to subscriber cell-phones. Alert-specific code words trigger these programs in areas covered by selected cell towers. Persons of priority (P1 and P2 like head-of-households) having a roster of the cell phone numbers plus respective coordinates of their family members in their cell phone memory can view their dependent's location on their display relative to the incident coordinates for aiding in a decision on safety measures. After an incident the P1's and P2's family roster in the cell-phone's carrier's memories and in the data center can help in family reunions and in rescue efforts.

### FIELD OF THE INVENTION

This invention pertains to the field of mobile telephone communications, especially for danger alerts.

### BACKGROUND

Public media like TV and radio, with a data feed from the National Oceanic and Atmospheric Administration (NOAA), have been instrumental in spreading warnings of severe weather conditions like tornados and hurricanes that potentially threaten lives. These media are area-covering, tending to provide warnings to more people than those in the direct path of the incident. Many people have been frustrated by frequent false alerts, when nothing happens within sight of their neighborhood, or they were asleep missing out on alerts.

### SUMMARY OF THE INVENTION

The widespread ownership of cell phones, even by school children, associated near gap-less coverage within the country with cell towers extends the possibility of applying cell-phones and satellite phones, preferably equipped with GPS, for danger alerts. As exemplified by tornado alerts, GPS-equipped cell-phones receiving alert signals from selected cell towers in the incident area can deliver reliable pin-pointed danger warnings, repeated several times before any acute danger appears. Proprietary programs tailored to the danger, are downloaded to a cell phone from a data center DCTR. Upon transmission of a specific code word following a data-feed from NOAA plus GPS coordinates of the danger peak, these programs issue verbally, as video or as a text message the respective alert to the cell phone carrier. A collection of cell-phone numbers plus present GPS coordinates for all dependents in their cell phone memory enables a head-of-household, to display the GPS coordinates of their dependents in relation to the impending danger's location, direction and speed for implementing safety measures. The roster of relevant cell-phones numbers may enable speedy family reunions after the incident and support rescue operations.

### IN THE DRAWINGS

FIG. 1 shows the control and voice channels of a cell phone band;

FIG. 2 illustrates the time sequence of NS/WE aligned incident boxes of a super-cell;

FIG. 3 depicts the time sequence of incident direction aligned incident boxes of a super-cell.

### DESCRIPTION OF THE PREFERRED EMBODIMENT

As Global Warming appears to change the weather patterns throughout the United States and the rest of the world, it is said to increase the number of severe weather conditions. A more effective emergency alert notification is needed to alert affected people. As a result of disasters like those affecting New Orleans, La. (Katrina August 2004) and Greensburg, Kans. (April 2007) it is obvious that there is a requirement for a superior warning system for the public. The present invention proposes the use of mobile phones (MPs), cell phones (CPs), mobile wireless devices, wired and wireless Internet connected devices, PDAs, satellite phones etc. This concept is illustrated in this description using CPs to notify people of dangerous incidents in a timely and accurate manner. Such incidents are potential severe weather conditions such as tornados, hurricanes, floods, snow storms, tsunamis, wild fires etc as well as man-made disasters like fires, chemical spills, traffic pileups, abductions (AMBER Alert), terrorist actions, educational institution shootings etc. Another use of cell phones is in facilitating a family notification or reunion after the event, and in the coordination of individual and community disaster relief efforts in cooperation with the Federal Incident Command System (fics) of the Federal Emergency Management Administration (FEMA). Transmission of alerts is facilitated through a broadcast method associated with a stationary or moving rectangular box display (“incident box” IB) on the CP via GPS or geographical coordinates to selected cell towers in the affected area. This permits a much more focused approach to reach cell-phone carriers (CPCs) than employing area-covering TV and Radio broadcasts. Warnings and alerts are used interchangeably in this description. GPS or geographical coordinates in the following are just called “coordinates”.

Each year from April through October weather conditions exist through northern hemisphere countries that may result in life-threatening situations. Moisture-laden air from the warm waters of the Gulf of Mexico flow north, while cold air flowing east over the Rocky Mountains mixes with the warm air on top resulting in a shearing action. These actions are promoted by the Coriolis force rotating counter-clockwise in the northern hemishere. This action results in a counter-clockwise rotating pattern leading to the formation of severe thunderstorms called “Super-cells”, usually moving eastward. About 25% of these super-cells evolve into tornados, classified from F1 to F5 by radar measurements of the speed of debris carried in a tornado. The highest wind-speeds have been clocked at 318 mph (518 kmph) in an F5. Inspite of warnings by radio and TV, it is evident that many people either don't get the message or ignore it (a possible sign of fatigue or even annoyance from too many false alarms) or being asleep when an incident threatens and a public announcement is made. Given the ubiquitous distribution of cell-phones with GPS capabilities, a well focused higher resolution approach is possible using existing cell-towers in such affected areas: 1) warnings in stages by different acoustic signals 2) facilitation of family reunions after the incident.
The infrastructure to implement this technique comprises (besides the subscribers cell phones):
a) a data-center DCTR housing a first database DB1 of all subscribers plus their families and housing a second database DB2 of the coordinates (in latitude and longitude) of all cell towers as obtained from the Federal Communications Committee (FCC), Washington, D.C. A software program SW1, based on JAVA or C with SQL, sorts out a subset of cell towers which fall into and around a box-shaped incident alert area IB (discussed later) around the present coordinates of an incident (super-cell, a tornado, hurricane etc.). The DCTR also houses a database DB3 of pre-scripted software SW2 for specific alerts, which are individually downloaded to subscriber's CPs and include the major roads and other landmarks in a subscriber's environment. The data center also contains a database DB4 of short codes to be broadcast (including coordinate info on an incident) by a meteorologist operator to subscriber's CP to trigger the specific down-loaded alerts. In addition within the DCTR resides database DB5 for a set of confirmed alert responders now responding (or not) to the “all clear” alert (discussed later), which may be an indication of wide-spread damage to be reported to FEMA, and for supporting family reunions.
b) sets of cell-towers that, aside from their regular function, can be addressed for pre-incident downloading of individual software programs SW2 from the DCTR to subscriber cell phones and for the code word broadcasts to subscribers mentioned above.

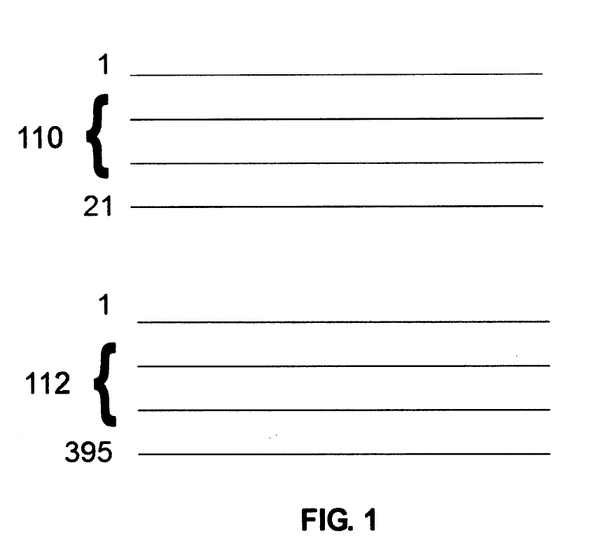

A cell band, at 700, 800 or 1,900 MHz, (Federal Communications Commission (FCC) allocation) has at least 395 voice channels plus 21 control channels (see items 110, 112 in FIG. 1). Each control channel and each voice channel consists of a transmitting and a receiving channel (referenced to the CP, each of a 10 kHz bandwidth). The CP signal is received by at least one antenna panel of a circular or semicircular arrangement of a multitude of rectangular antenna panels on a high point like a water or power transmission tower or on a special purpose tower, in general called cell tower CT, at a height of about 10 m (30 feet) above ground. A CT is a corner-point of a hexagonally shaped cell, about 2-10 miles from the next CT. Simple signal strength comparison allows the localization of a mobile phone within a specific cell with one CT with the maximum signal strength reception (CTM) retaining the connection while neighboring CTs with a weaker signal from this same mobile phone drop the connection. Upon acquisition of the CP signal the CTM drops by remote control the CP's transmitting power to a minimal level but with an acceptable signal-to-noise ratio. In general every CT periodically transmits about every 2 seconds a call signal (“Who is out there?”) on a control channel to solicit proximate CPs, even when not in use, to respond with a digital ID signal comprising a changeable MIN (Mobile phone ID Number, the mobile phone's three digit area code plus a 7 digit phone number, and an unchangeable ESN (Electronic Signature Number, a 32 bit binary number assigned by the handset manufacturer, and stored in a CP's Read-Only Memory [ROM]). The response of the CP to the CT's periodic query in a turned-off state enables the CP to make its proximity to a specific CTM known to the service provider on a control channel, so for an incoming call the provider immediately can sort out from its database which CT to send the call to and it will not have to poll thousands of CTs which would make economic operations unfeasible. In case of an incoming call the CT then assigns a voice channel to the calling CP for voice or text communications.

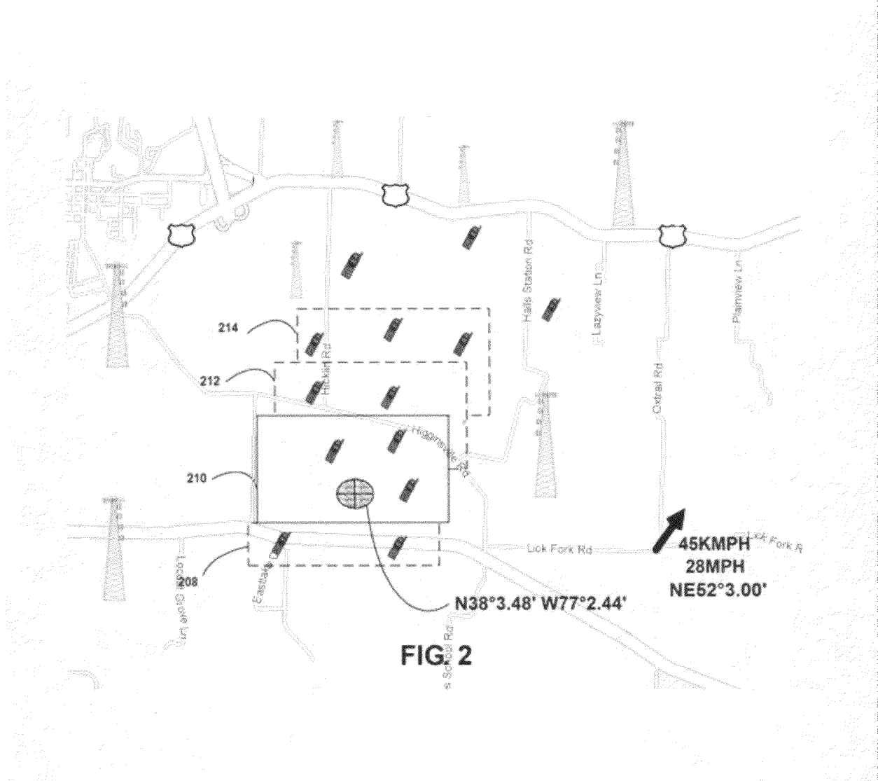

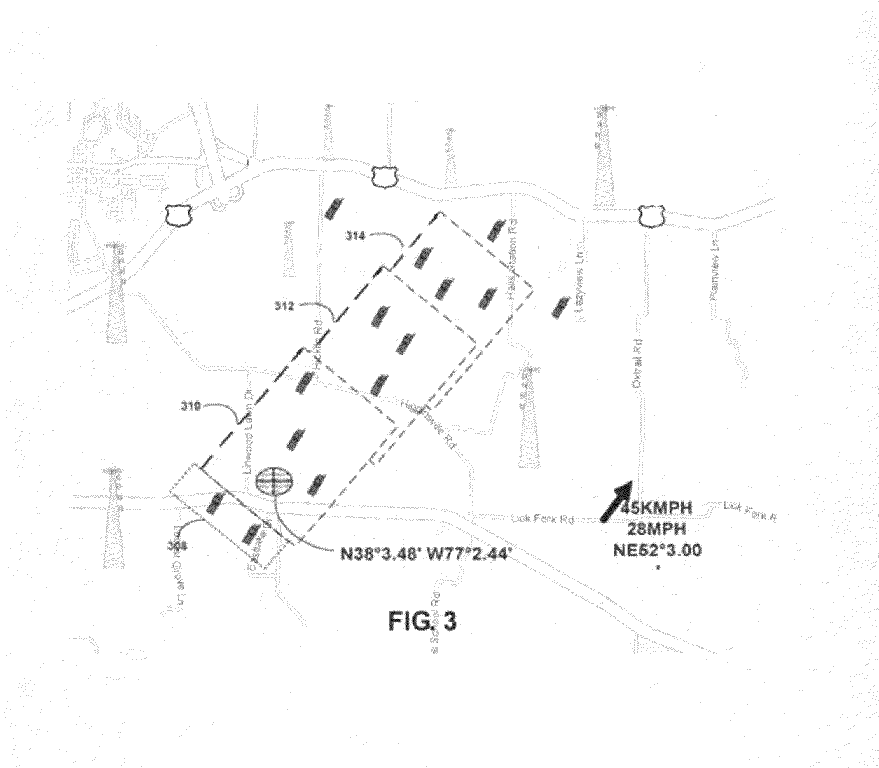

The weather incident info comes via a data feed from NOAA and other sources in the form of successive radar data maps with the peak activity center of a super-cell in white, surrounded by a red area. Items 208, 210, 212 and 214 in FIG. 2 show a time-sequenced display of IBs with the coordinates of the incident peak or center (N . . . , W . . . ), its speed in miles per hour (kilometers per hour) and its direction (0 and 360=N, 90=E, 180=S, 270=W). Another way of arranging the IB is to determine first the direction and speed (from two or more consecutive NOAA RADAR peak coordinates) in miles (kilometers) per hour. This info plus the coordinates of two opposing IB corners are processed by the DCTR and appended to the alert code word. By trigonometric calculations and drawing NS and WE parallels around the incident the incident box can be drawn on a CP carrier's display (see FIG. 2). Another way of arranging the IB as illustrated in FIG. 3 is to determine first the direction and speed (from two or more consecutive NOAA RADAR peak coordinates, calculated and transmitted by the DCTR) in miles (kilometers) per hour. This info plus the geographical coordinates of two opposing IB corners are appended to the alert code word. By trigonometric calculations and drawing parallels and perpendiculars to the incident direction through the IB corner coordinates, the incident box can be drawn on a CP carrier's display. The dotted line rectangles at the foot end (208 and 308 in FIGS. 2 and 3 respectively) represent the “All clear” notification area containing all previously alerted CP carriers, now out of danger. By counting the diameter of the red-pixel zone around the peak zone and including some arithmetic a yellow-rim scalable incident box (IB) is drawn parallel to and along NS and WE axes in degree minutes of latitude in the north-south axis and in degree minutes of longitude in the west-east axis. By trigonometric and time-sequence calculations the direction path and speed of the peak incident can be determined. The yellow IB moves with the peak activity zone of a super-cell similar to the movement of a computer-generated non-intrusion safety air space around an airplane guided by an FAA air controller. If a super-cell spawns a tornado in addition to the display of the yellow IB, for the tornado's lifetime, a red tornado IB of possibly different size is displayed (tornados sometimes show unpredictable movements dependent on pressure differentials around their perimeter). The alerts are going to the adults/adolescents of a family or selected members of the group to insure that each group member receives the proper alert via the family/group roster of CP numbers. The goal is to let a CP carrier see the incident coordinates in relation to their own location on her/his CP map display, thus enabling her/him to assess future action plans like collecting his/her loved ones, finding escape routes, rushing to shelters etc. The IB separates the “Take cover” zone (inside) from the “Pay attention” or “Stay away” zone (outside). Alerts are designed to provide redundancy. People in the path of the incident should receive at least two general warnings and two “Imminent Danger” alerts before the incident reaches their location, to account for people missing or ignoring it the first time (e.g. at night time). At least two different timings for each alert and at least two different pathways (to the head-of-household, P1 and to another mature adult/adolescent P2) for an alert are provided and the CP transmission times in critical times are minimized by broadcasting short code words for different danger categories which trigger the pre-scripted warning software residing in individual CPs. Alerts may have several stages distinguished by different acoustic signals and code words that triggered the pre-scripted acoustic, video and text info:
a) a “Warning” signal is issued about 20 miles around the geographic center of a super-cell (yellow IB, see below), updated every few minutes with new incident info (see below). hitting a subscriber's CP at least twice before the super-cell reaches the cell-phone's location, and assuming a realistic super-cell movement of about 30 mph, to be refined after the true super-cell speed is calculated. To avoid a nuisance, the CP carrier has the option to push a specific button to switch the second and following warnings to a silent text mode announced by a short beep. The exact super-cell data come from a subscription data feed from the National Oceanic and Atmospheric Administration (NOAA) in Boulder, Colo. The incident zone (e.g. a supercell) is displayed as a yellow IB on a respective CP screen.
b) a “Immediate Danger” signal is transmitted when a super-cell has spawned a tornado, even if its F-class is not immediately known and even if it has not touched the ground, as reported by the Severe Weather Department of the University of Oklahoma in Norman, Okla. A tornado warning has the highest urgency pitch. The yellow IB around a super-cell is overlayed with a superimposed red zone IB for the lifetime of the respective tornado (usually about one hour or less). The alert includes the incident update info. It can not be switched off to a silent text mode.
   The incident info includes the coordinates of the main incident activity (North degrees, minutes and seconds, West degrees, minutes and seconds) plus its speed and direction) for the CP carrier's GPS (NS and WE aligned) display plus the coordinates of diagonally opposed corners for a definition and display of yellow and red IBs.
c) an “All Clear” signal indicates that a tornado or super-cell has moved past the location of the people having received “Warning” or “Immediate Danger” signals, to inform them of the more relaxed situation but advising them to be alert to an unstable atmosphere (lightning strikes still possible). These areas are indicated by items 208 and 308 in FIGS. 2 and 3, respectively. The All-Clear areas have to be screened for endangered lives and damage. The All Clear signal includes an inquiry asking whether the CP carrier needs immediate assistance. The CP's response is sent to the DCTR and distributed to the P1 and P2 and to the FEMA command center. If in a certain area CPs responded to alerts but not to all-clear signal, it maybe an indication of wide-spread damage to be reported to FEMA or State Offices of Emergency Services.
All DCTR signals are acknowledged by the software in the recipient's CP back to the DCTR (on a cell-band control channel) including a date and time stamp to assure proper delivery. The appropriate audio, video or textual contents of these alerts (SW2) are pre-scripted, programmed and downloaded (at low traffic times) to individual CPs to be triggered and activated by a specific short code word broadcast simultaneously to all subscriber CPs within reach of the selected subset of cell-towers and includes the incident info (see above). This short (about 100 msec) codeword plus incident info is sent to the subscriber and interrupts a possibly ongoing CP conversation for its duration (which may be around 100 to 200 msec).

Incident boxes IBs for different alerts can be static (e.g. a college held hostage by a psychotic shooter) or dynamic (mostly weather related). A dynamic incident box is configured around the center (peak activity) of the incident in a successive movement given by the coordinates of the dynamic incident. The width and length of the IB are determined by the red pixel width of the NOAA provided radar image plus the NS and WE components, respectively, of the speed and direction of the incident. They may be calculated between displays (one every few minutes) to allow for an early alert of about 30 to 40 minutes before the storm arrives at that location of the CP carrier. The box shape is generated at the DCTR, with two defining diagonally opposed corners of an IB every few minutes for super-cell as well as for tornados, transmitted to the subscribers.
Upon signing up for the warning service the head of a household (HH or priority person P1) inputs into his cell memory the family status, birth year, name (or nick-name) and the (cell or land-) phones numbers of all family members and possibly the Radio Frequency ID (RFID) of chips implanted into their family pets. Special info is included, e.g severe health alerts like heart conditions, diabetes etc. A mature family member P2 copies that family info into her/his memory. A single person is P1 of a household of one. A proposal is head of household P1, P2, FM X (X=number of total family members including friends and pets), P1's and P2's CP#, family address, then names, status and CP # of family members. The status designations are: A1-10 adults (including P1, P2), T 1-10 teens (in descending order of age), K1-10 kids (age 6-12), F1-10 friends, PT 1-5 pets, N1-5 neighbors (shelter for kids). The family plus friends, neighbors and pets is called a group here. This info will be transmitted to the DCTR and if P1 determines the data beneficial to all family/group members it can be downloaded to all other family members (downloads and alerts will be individually acknowledged back to the DCTR on a control channel with a time and date stamp by the pre-scripted software in a CP carriers phone). Only family members receive the warnings, but the group including friends and pets participates in the reunion notification after the incident. Upon the first warning all family/group members press a special keyboard speed button which initiates the transmission of each family member's present coordinates to the P1 and P2. This enables these two to depict the family member's location in relation to the danger coordinates in support of prudent decision making about everyone's safety. These data are also essential for after-incident rescue efforts and may be shared with FEMA, unless there is another agreement with the household head. In case of danger all CP carriers of a family will receive warning signals. This procedure enforces correct data entry, storage and acknowledged warnings. Datacenter DCTR also houses a database DB2 containing subscriber family info as outlined above, which may be used in a danger situation, a rescue operation and also in fire drills.

For a hurricane the reference is the movement of the center of the eye. The diameter of the hurricane is the circle of the outer clouds and is related to the wind speeds there. A landfall occurs when the eye-wall touches the coastline tangentially. Due to the counter-clockwise circulation one would expect at landfall northerly winds on the Atlantic coast, southerly winds at the Gulf Coast of Florida and easterly winds at the northern Gulf Coast. The danger comes from the wind force (up to 220 mph for H5 hurricanes) of changing direction due to the hurricane movement, possibly from torrential rains, but the most severe dangers are coming from the storm surge of ocean waters (often up to 20 feet), due to decreased surface pressure which can flood coastal areas (Katrina 2005). 80 to 90% of hurricane victims die from drowning. The warning effort is important for a more accurate landfall info and should be informative for returning families as to which roads are flooded and which traffic jams to avoid (possibly from satellite images and email info from counties around the affected area).

In case of a terrorist attack, say a dirty bomb, this warning system may be employed advantageously to warn discretely sensitive populations like pregnant women, medical personnel etc. to leave the radioactive plume area (depending on the wind speed and direction) to avoid panic traffic jams especially in bottlenecks near bridges.

Emerging from a passing danger zone or from an incident individuals want to be comfortable in knowing that loved ones (family, relatives, friends, even family pets preferably identified by an implanted RFID tag) are safe and within at least telephone reach. Cell phones are uniquely suited for this task. Since all CP numbers of individual families are stored in the memory of the P1 (as well as in the DCTR) including their coordinates, a family reunion can be facilitated, possibly impaired by the limitation of CP battery charges of individual CPs.

Besides using CPs an alert system can also be implemented using satellite phones (SPs). A satellite transmission ST does not suffer from signal attenuation by radio-beam-obstructing geographic obstacles and can reach a wider geographic area. While the CP scheme uses selected cell towers in the incident area, ST operates by contacting SPs in the danger area by their last known GPS coordinates. The satellite broadcasts (under the control of the DCTR) first a “turn-on” signal for the SP, then the IB opposed corner coordinates and speed and direction of a super-cell. Each individual SP carrier then determines from its own GPS coordinates the distance and direction from the super-cell. If the SP is not in the path of the incident, it disables the alert code reception for a certain time (e.g. 5 min). If certain criteria are met, the SP transmits to the DCTR and its HH its MIN, ESN and coordinates, date and time stamped. The DCTR subsequently broadcasts alerts code words via satellite and the issue proceeds similar to the CP case.

Summarizing: the invention, by utilizing the details of mobile phone communications specifications, allows incident alerts to be broadcast efficiently and timely by code word to arbitrarily large numbers of endangered subscribers. Family info is collected by Heads-of-Households (priority persons P1 and P2) and uploaded to a database in the DCTR for planning family safety, family reunions after the incident and for a possible support for rescue efforts. A pre-downloaded pre-scripted audio/video/text alert, co-located in a subscriber's cell phone memory, reduces cell tower alert broadcast time. It is triggered by a broadcast codeword plus incident coordinate info plus time/date info, thus minimizing interruption of regular cell tower or satellite operations. The facilitating of family reunion messages (acknowledgement of “all clear” broadcasts) at least reduces the need for cell phone calls for the whereabouts of their loved ones (“worry calls”), a volume that may otherwise overwhelm the capacity of cell towers and paralyze the cell phone system. All alerts and messages are confirmed, by the downloaded software, back to the DCTR, thus providing legal evidence and enabling feedback on fire drills. If in a certain area CPs responded to alerts but not to all-clear signal, it maybe an indication of wide-spread damage to be reported to FEMA or pertinent State Offices of Emergency Services (OES). All critical info including the yellow (supercell) and red (tornado) incident box coordinates are processed and broadcast by the DCTR.

What is claimed is:

1. A system of hardware and software employed to communicate wirelessly with mobile phones carried by subscribers in areas with emerging incidents, the system comprising:
a. a data center holding a first data-base DB1 of all subscribers and their families;
b. the data center also holding a second database DB2 of communication means including cell towers and satellites, in the vicinity and within wireless range of subscribers owning mobile phones;
c. the data center also holding a third database DB3 of pre-scripted software SW2 for specific alerts in audio, video and text and specific environmental landmark info to be downloaded to subscribers cell phones before an incident;
d. the data center also holding a fourth database DB4 of short codes to be broadcast, including coordinate info of an incident, to subscriber's cell phones to trigger the specific alerts;
e. the data center also holding a fifth database DB5 for collecting a set of confirmed alert responders now expected to respond to an “all clear” alert, if negative, may be an indication of wide-spread damage; and
f. a set of cell towers which, aside from their regular function, can be addressed for pre-incident downloading of individual software SW2 from the data center to subscriber cell phones and for code word broadcasting to subscriber cond operating software residing at the data center to be down-loaded into the memory of a mobile phone of an individual subscriber.

2. A method for displaying an incident on the screen of a mobile phone, comprising the steps of:
a. obtaining the coordinates of the center and peak activity of the incident;
b. recording an alert broadcast time interval sequence of incident coordinates of the center of the incident for the calculation of incident speed and incident direction, referenced to true North;
c. obtaining an incident box drawn by drawing lines of the incident direction and lines perpendicular to the incident direction through the diagonally opposed corner points coordinates broadcast from the data center, the incident box separating a “take cover” inside zone from a “stay away”/“pay attention” outside zone; and
d. displaying a coordinate map of the incident box and its environment including landmarks to enable a cell phone carrier to recognize his GPS location relative to the incident.

3. A method for enhancing the reliability of an alert broadcast while minimizing cell-tower transmission times and supporting family reunions, comprising the steps of:
a. pre-scripting different alerts in audio, video and text, to be triggered by broadcast short code words each, and downloading this alert info to subscribing cell phones at low-traffic times prior to the incident;
b. broadcasting the code words for respective alerts with the present coordinates of the incident alert at least twice a short time apart to all family members to give them with enough time for evasive action;
c. displaying at least to priority persons P1 and P2 their location in relation to the coordinates of the incident, augmented by a display of pertinent landmarks;
d. relaying acknowledgements for receiving the respective alerts, generated by the downloaded software on a subscriber's cell phone, on cell phone control channels back to the data center; and
e. using the responses of cell-phones to alerts back to the data center and comparing them to the potential absence of responses from the same cell-phone after an “all-clear” signal to determine areas of endangerment of lives and wide-spread damage as info to first responders.
